(19) United States
(12) Patent Application Publication
(10) Pub. No.: US 2009/0128521 A1
(43) Pub. Date: May 21, 2009

(54) STYLUS AND PORTABLE ELECTRONIC DEVICE EMPLOYING THE SAME

(75) Inventor: CHIEN-CHIH CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/964,882

(22) Filed: Dec. 27, 2007

(30) Foreign Application Priority Data
Nov. 20, 2007 (CN) 200710202598.2

(51) Int. Cl. G06F 3/033

(52) U.S. Cl. 345/179

(57) ABSTRACT

A portable electronic device (60) includes a housing (70) having a magnet (704) held therein and a stylus (80). The stylus has a body (802) and a magnetic piece (804) received in the body. The stylus is received in the housing by the engagement of the magnet and the magnetic piece.

### BACKGROUND OF THE INVENTION

1. Field of the Invention

The present invention generally relates to styluses and, particularly, to a stylus used as an input device on a pressure-sensitive screen of a portable electronic device.

2. Discussion of the Related Art

With the recent development of the technology of information processing, portable electronic devices such as mobile phones and personal digital assistants (PDAs) are now in widespread use. The portable electronic device generally has a large screen and the screen is typically pressure-sensitive. A stylus is used as an input device for writing, marking, or engraving on the pressure-sensitive screen.

In some electronic devices, the stylus is mounted to/into a housing of a given electronic device. The housing of the electronic device has a deep hole defined, e.g., in one sidewall thereof. An extending direction of the hole is substantially parallel to the sidewall. The stylus is substantially a thin and long pole. The stylus is configured (i.e., structured and arranged) for being received in the hole of the housing by friction therebetween and may be pulled out manually from the hole. However, the friction between the stylus and the housing may decreased due to insertion and withdrawal of the stylus repeatedly.

Therefore, a new stylus for portable electronic device is desired in order to overcome the above-described shortcoming.

### SUMMARY

In one aspect thereof, a portable electronic device includes a housing having a magnet received therein and a stylus. The stylus has a body and a magnetic piece received in the body. The stylus is received in the housing by the magnetic engagement of the magnet and the magnetic piece.

Other advantages and novel features of the embodiments will become more apparent from the following detailed description thereof when taken in conjunction with the accompanying drawings.

### BRIEF DESCRIPTION OF THE DRAWINGS

Many aspects of the present stylus and portable electronic device can be better understood with reference to the following drawings. The components in the drawings are not necessarily to scale, the emphasis instead being placed upon clearly illustrating the principles of the present stylus and portable electronic device. Moreover, in the drawings, like reference numerals designate corresponding parts throughout the several views.

FIG. 1 is an isometric view of a portable electronic device employing a stylus, in accordance with a present embodiment.

### DETAILED DESCRIPTION OF THE EMBODIMENT

The present stylus is particularly suitable for portable electronic devices such as mobile phones, PDAs, and the like. Other applications could also be found in which a similar stylus is employed.

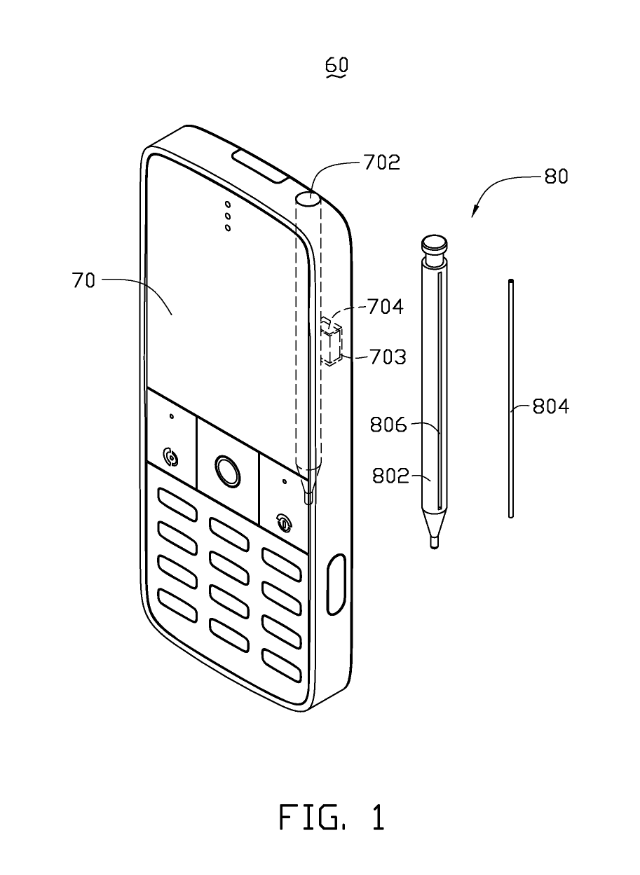

Referring to the drawing in detail, FIG. 1 shows a portable electronic device 60 having a stylus 80. The stylus 80 is configured for being receivable in the portable electronic device 40.

The portable electronic device 60 has a housing 70 and a magnet 704 received in the housing 70. The housing 70 is a substantially rectangular block, and defines a thin and long cavity 702 and a rectangular recess 703 in a sidewall thereof. The cavity 702 communicates with the recess 703. The recess 703 is located adjacent to a center of the cavity 702. The magnet 704 is a rectangular block and is received in the recess 703. In the present embodiment, the magnet 704 may be a permanent magnet, an electromagnet, a microphone magnet, or a receiver magnet in the housing 70.

The stylus 80 has a body 802 and a magnetic piece 804 received in the body 802. The body 802 is substantially cylindrical in shape and is configured for being receivable in the cavity 702 of the housing 70. The body 802 defines a groove 806 in a peripheral wall thereof. The groove 806 extends in a direction parallel to an axis of the body 802. The magnetic piece 804 is a substantially thin and long pole and is configured for being receivable in the groove 806. The magnetic piece 804 may be made of iron, cobalt, nickel, or alloy thereof.

After the stylus 80 is inserted to the housing 70, the magnet 704 is received in the recess 703, the magnetic piece 804 is received in the groove 806, and the stylus 80 is received in the cavity 702 of the housing 70. The magnetic piece 804 is firmly held in the housing 70 due to magnetic engagement between the magnetic piece 804 and the magnet 704.

In use, the stylus 80 can be pulled out manually from the cavity 702 and functions as an input device for writing, marking, or engraving on a pressure-sensitive screen of the housing 70. The magnetic piece 804 may be taken out from the groove 806 and be used with a line as a compass to determine geographic direction.

It is to be understood that the magnetic piece 804 may be a permanent magnet.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device comprising:
a housing having a magnet received therein; and
a stylus having a body and a magnetic piece received in the body, the stylus being received and confined in the housing by the magnetic engagement of the magnet and the magnetic piece.

2. The portable electronic device as claimed in claim 1, wherein the housing is a substantially rectangular block in shape, and defines a thin and long cavity configured for receiving the stylus therein, and a recess defined in a sidewall of the cavity for receiving the magnet.

3. The portable electronic device as claimed in claim 2, wherein the cavity communicates with the recess.

4. The portable electronic device as claimed in claim 2, wherein the recess is located adjacent to a center of the cavity.

5. The portable electronic device as claimed in claim 1, wherein the body of the stylus is substantially cylindrical in shape and defines a groove in a peripheral wall thereof.

6. The portable electronic device as claimed in claim 5, wherein an extending direction of the groove is parallel to an axis of the body.

7. The portable electronic device as claimed in claim 1, wherein the magnet is one of a permanent magnet, an electromagnet, a microphone magnet, and a receiver magnet provided in the housing.

8. The portable electronic device as claimed in claim 1, wherein the magnetic piece is made of a material chosen from a group consisting of iron, cobalt, nickel, and alloy thereof.

9. The portable electronic device as claimed in claim 1, wherein the magnetic piece is a permanent magnet.

10. A stylus for a portable electronic device, the stylus comprising:
a body defining a groove therein; and
a magnetic piece received in the groove.

11. The stylus as claimed in claim 10, wherein the body of the stylus is substantially cylindrical in shape and defines the groove in a peripheral wall thereof.

12. The stylus as claimed in claim 11, wherein an extending direction of the groove is parallel to an axis of the body.

13. The stylus as claimed in claim 10, wherein the magnetic piece is made of a material chosen from a group consisting of iron, cobalt, nickel, and alloy thereof.

14. The stylus as claimed in claim 10, wherein the magnetic piece is a permanent magnet.
